(19) United States
(12) Patent Application Publication
(10) Pub. No.: US 2011/0159458 A1
(43) Pub. Date: Jun. 30, 2011

(54) Endodontic Instrument With Modified Memory and Flexibility Properties and Method

(76) Inventors: Derek E. Heath, Vero Beach, FL (US); Steven J.A. Treadway, Jonesborough, TN (US); Bobby J. Bennett, Johnson City, TN (US)

(21) Appl. No.: 12/950,536

(22) Filed: Nov. 19, 2010

Related U.S. Application Data
(60) Provisional application No. 61/263,192, filed on Nov. 20, 2009.

(51) Int. Cl. A61C 5/02; C21D 9/00; C21D 1/00

(52) U.S. Cl. 433/102; 148/559; 148/714

(57) ABSTRACT

Medical instruments, particularly, endodontic instruments with unique limited memory characteristics, and methods for making such instruments. One embodiment includes heat treating a finished endodontic instrument. A related embodiment includes electropolishing a finished endodontic instrument and then heat treating the endodontic instrument.

### CROSS-REFERENCE(S) TO RELATED APPLICATION(S)

This application claims priority to U.S. Provisional Patent Application No. 61/263,192 entitled Endodontic Instrument With Modified Memory and Flexibility Properties and Method to Bennett et al. filed on Nov. 20, 2009, the content of which is incorporated herein by reference in its entirety.

### FIELD

This disclosure relates to the field of medical instruments and manufacturing treatments therefor. More particularly, this disclosure relates to endodontic instruments and methods for manufacturing such instruments to provide endodontic instruments with unique desired properties.

### BACKGROUND

The present invention relates to endodontic instruments and to methods of making such instruments. In particular, the invention relates to nickel-titanium or “NiTi” endodontic instruments that exhibit beneficial properties and characteristics for working in a manner so as to avoid difficulties associated with prior instruments including, but not limited to, undesired lateral transportation in curved canals, difficulties with enlarging curvilinear canals while substantially maintaining the original center axis of the canals, and problems with binding and/or “screwing in” of prior NiTi instruments in such canals.

### SUMMARY

The above and other needs are met by a method for modifying a physical characteristic of a medical instrument. The method comprises the steps of placing a medical instrument (e.g., an endodontic instrument) in a heated environment having a temperature of from about 450° C. to about 550° C. for from about 90 minutes to about 300 minutes, wherein the medical instrument is made from at least about 50% by mass of a superelastic alloy. Preferably, the endodontic instrument comprises a tapered endodontic instrument made of a nickel-titanium composition and configured as a file, rasp, broach, or other device for cleaning, scraping, extirpating, and/or debriding a root canal of a tooth. In one embodiment, the instrument is placed in the heated environment for a period from about 120 minutes to about 150 minutes. In a related embodiment, the instrument is placed in the heated environment for a period from about 180 minutes to about 300 minutes. In one embodiment, the placing step further comprises placing the endodontic instrument in a heated gaseous environment having a gas temperature of from about 490° C. to about 510° C. wherein the gaseous environment preferably is ambient air.

Preferably, the instrument undergoes a machining step to form a working portion prior to placing the endodontic instrument in the heated environment.

In one embodiment, the method for modifying a physical characteristic of an endodontic instrument described above is made by further including a step of electropolishing the endodontic instrument prior to placing the endodontic instrument in the heated environment.

In one embodiment, the placing step further includes placing the endodontic instrument in a heated gaseous environment having a gas temperature of from about 490° C. to about 510° C. wherein the gaseous environment preferably is ambient air. The method further may include a step of electropolishing the endodontic instrument prior to placing the instrument in the heated environment. In a preferred embodiment, the placing step further includes a step selected from the group consisting of heat treating the endodontic instrument for at least 120 minutes if the endodontic instrument has a core diameter ranging from about 1.9×10⁻² mm to about 3.1×10⁻² mm; heat treating the endodontic instrument for from at least 120 minutes to about 240 minutes

In another aspect, embodiments of the disclosure provide an endodontic instrument with modified memory characteristics, the endodontic instrument made by the various method embodiments described above and including, for example, a method including the steps of placing an endodontic instrument in a heated environment having a temperature of from about 450° C. to about 550° C. for from about 90 to about 300 minutes, wherein the endodontic instrument is made from at least about 50% by mass of a superelastic alloy. In one embodiment, the step of placing the endodontic instrument in a heated environment further comprises placing the endodontic instrument in the heated environment for from about 180 minutes to about 300 minutes.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1A shows a further somewhat schematic representation of a tooth root canal being operated on using a dental instrument;

FIG. 1B shows a somewhat schematic representation of a tooth being operated on using a dental instrument;

FIG. 2 shows a two-dimensional plot of torque data (vertical axis) versus angular deflection data (horizontal axis) for untreated (“control”) NiTi instruments;

FIG. 3 shows a two-dimensional plot of the data in FIG. 2 wherein the data sets have been fitted to conform to third degree polynomial equation curves;

FIG. 4 shows a two-dimensional plot of torque data (vertical axis) versus angular deflection data (horizontal axis) for several NiTi instruments treated according to one embodiment of the invention;

FIG. 5 shows a two-dimensional plot of torque data (vertical axis) versus angular deflection data (horizontal axis) for several NiTi instruments treated according to another embodiment of the invention;

FIG. 6 shows a two-dimensional plot of torque data (vertical axis) versus angular deflection data (horizontal axis) for several NiTi instruments treated according to a further embodiment of the invention;

FIG. 7 shows a two-dimensional plot of torque data (vertical axis) versus angular deflection data (horizontal axis) for several NiTi instruments treated according to an additional embodiment of the invention;

FIG. 8 shows a two-dimensional plot of the data in FIG. 7 wherein the data sets have been fitted to conform to third degree polynomial equation curves;

FIG. 9 shows an apparatus used to test cyclical fatigue of a dental instrument;

FIG. 10 shows a two-dimensional plot of torque data (vertical axis) versus angular deflection data (horizontal axis) for twenty NiTi instruments treated according to an embodiment of the invention;

FIG. 11 shows a two-dimensional plot of the data in FIG. 10 wherein the data sets have been fitted to conform to third degree polynomial equation curves;

FIG. 12 shows the two-dimensional plot of torque data (vertical axis) versus angular deflection data (horizontal axis) shown in FIG. 11 further including a superimposed curve generated from the average values of the coefficients for the third degree polynomial equations used to fit the data from FIG. 10 in the curves shown in FIG. 11;

FIG. 13 shows comparative cyclical fatigue measurements including those involving heat treated instruments with no prior electropolishing step as compared to heat treated instruments that had undergone a prior electropolishing step;

FIG. 14 shows comparative torque measurements including those involving heat treated instruments with no prior electropolishing step as compared to heat treated instruments that had undergone a prior electropolishing step;

FIG. 15 shows comparative angular deflection measurements including those involving heat treated instruments with no prior electropolishing step as compared to heat treated instruments that had undergone a prior electropolishing step;

FIG. 16 shows comparative cyclical fatigue measurements including those involving nickel titanium instruments with no prior heat treatment or electropolishing step (“NT”), heat treated instruments with no prior electropolishing step (“NT+HT”), and heat treated instruments that had undergone a prior electropolishing step (“NT+HT+EP”);

FIG. 17 shows comparative torque measurements including those involving nickel titanium instruments with no prior heat treatment or electropolishing step (“NT”), heat treated instruments with no prior electropolishing step (“NT+HT”), and heat treated instruments that had undergone a prior electropolishing step (“NT+HT+EP”);

FIG. 18 shows comparative angular deflection measurements including those involving nickel titanium instruments with no prior heat treatment or electropolishing step (“NT”), heat treated instruments with no prior electropolishing step (“NT+HT”), and heat treated instruments that had undergone a prior electropolishing step (“NT+HT+EP”); and

FIG. 19 shows the torn cross section of a heat treated endodontic instrument after testing wherein the instrument had been heat treated according to an embodiment of the invention prior to such testing.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

mN·m: the unit symbol for milli-Newton·meter.
m: the length unit symbol for meter.
mm: the length unit symbol for millimeter.
Working portion: That part of an endodontic instrument which includes surface features for removing material from a root canal including, but not limited to, surface features for scraping, shaving, cutting, penetrating, excavating, and/or removing material from canal wall surfaces in an effort to shape and/or enlarge a root canal.

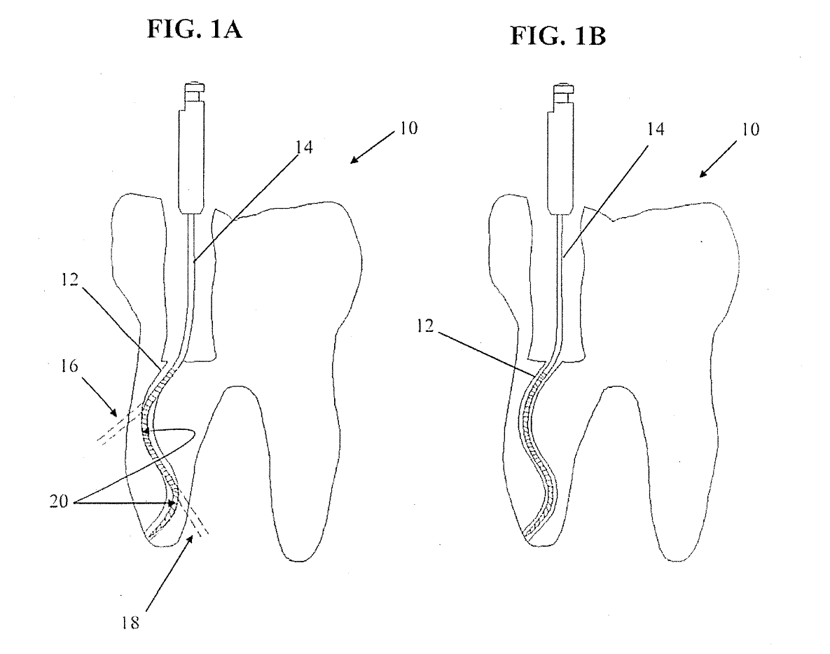

FIGS. 1A and 1B show somewhat schematic representations of a tooth 10 including a natural root canal 12 in which an endodontic instrument 14 is being used to extirpate the natural root canal 12. When devices such as the endodontic instrument 14 shown in FIG. 1A are made from nickel-titanium (or “NiTi” or “Nitinol”), such devices tend to have improved flexibility properties relative to similar devices made of stainless steel. This property of NiTi and other similar alloys is sometimes referred to in part as superelasticity or psuedoelasticity and is often lauded as a unique and beneficial characteristic of endodontic files made from NiTi.

As FIG. 1A shows, however, when NiTi endodontic devices such as tapered files are used to navigate, for example, the natural root canal 12 of the tooth 10, the tendency of the device 14 to veer to a path contrary to the natural root canal 12 shape is a continuous concern for a dental practitioner—particularly when the instrument is used along a natural root canal with excessive curvature. A first deviation path 16 and a second deviation path 18 are shown in FIG. 1A to illustrate the manner in which an instrument made of NiTi tends to create disproportionate lateral forces along an inner surface 20 of the natural root canal 12 at certain locations. If this tendency is not carefully monitored by a dental practitioner, such instrument could easily (and often does) deviate from the natural root canal 12, boring an artificial structure which has the potential to compromise an entire tooth structure.

In an attempt to address the drawbacks associated with NiTi dental instruments as used in endodontic procedures discussed above, the inventor has performed a number of experiments in an effort to increase the beneficial flexibility properties of NiTi which, in turn, decreases the lateral forces exerted by a NiTi dental instrument on the inner surface of a tooth root canal. The inventor has surprisingly found a method for treating machined NiTi instruments that increases the flexibility of such instruments.

In a first study, the Applicant performed twenty five tests using ADA guidelines (discussed infra) on five groups of endodontic files for properties including torque and angular deflection to see if various heat treatment methods had any effect on the relative performance of the files. Trends of interest became apparent based on the visual “signature” of each set of data sets. Table 1 below indicates relationships between each group of tests with various parameters.

TABLE 1

| | Ave. Torque | Ave. Angular Deflection |
|---|---|---|
| | (mN · m) | (Revolutions) |
| Control Group | about 2 | 1.61 |
| Experimental Group 1 | less than 2 | 2.89 |
| Experimental Group 2 | unstable data | 3.32 |
| Experimental Group 3 | unstable data | 3.69 |
| Experimental Group 4 | about 2 | 4.05 |

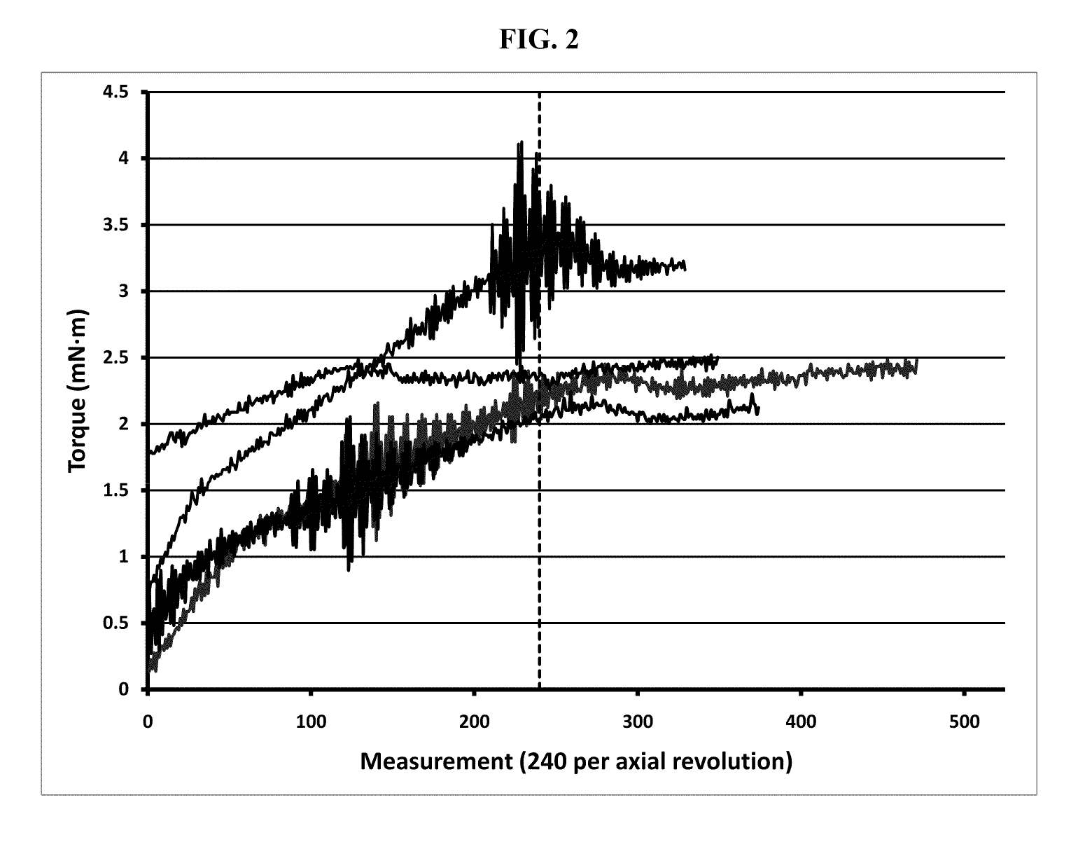

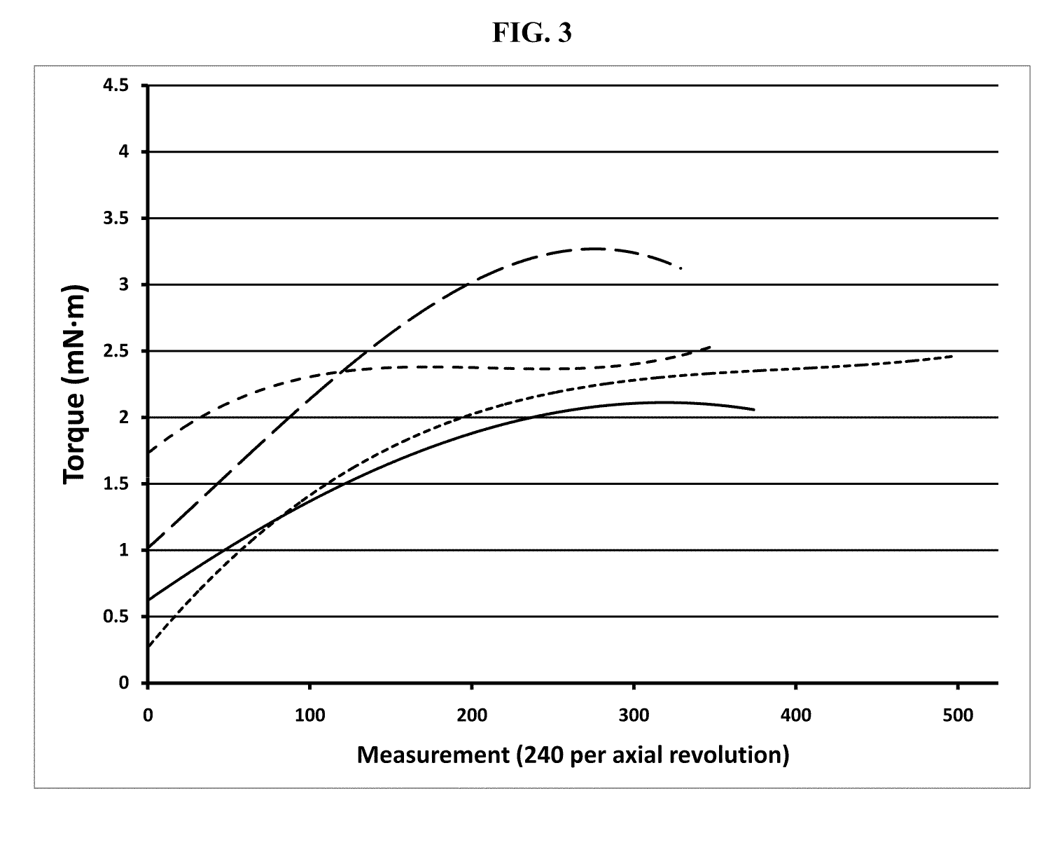

Graphs shown in FIGS. 2-8 plot torque (vertical axis) versus angular deflection (horizontal axis). In each of the graphs shown in FIGS. 2-8, 240 measurement samples for torque versus angular deflection were taken per one full axial (twisting) revolution of the instrument. FIG. 2 shows a graph of four data sets representing four separate test samples included in the control group which included only NiTi instruments that had not been heat treated according to Applicant's treatment method. A fifth data set in the control group was discarded because of a testing fault with the sample. As can be seen in FIG. 2, all of the test runs of the control group displayed a similar graphical signature which is more easily seen in FIG. 3 wherein the data associated with each test sample was used to generate a second order polynomial trend line.

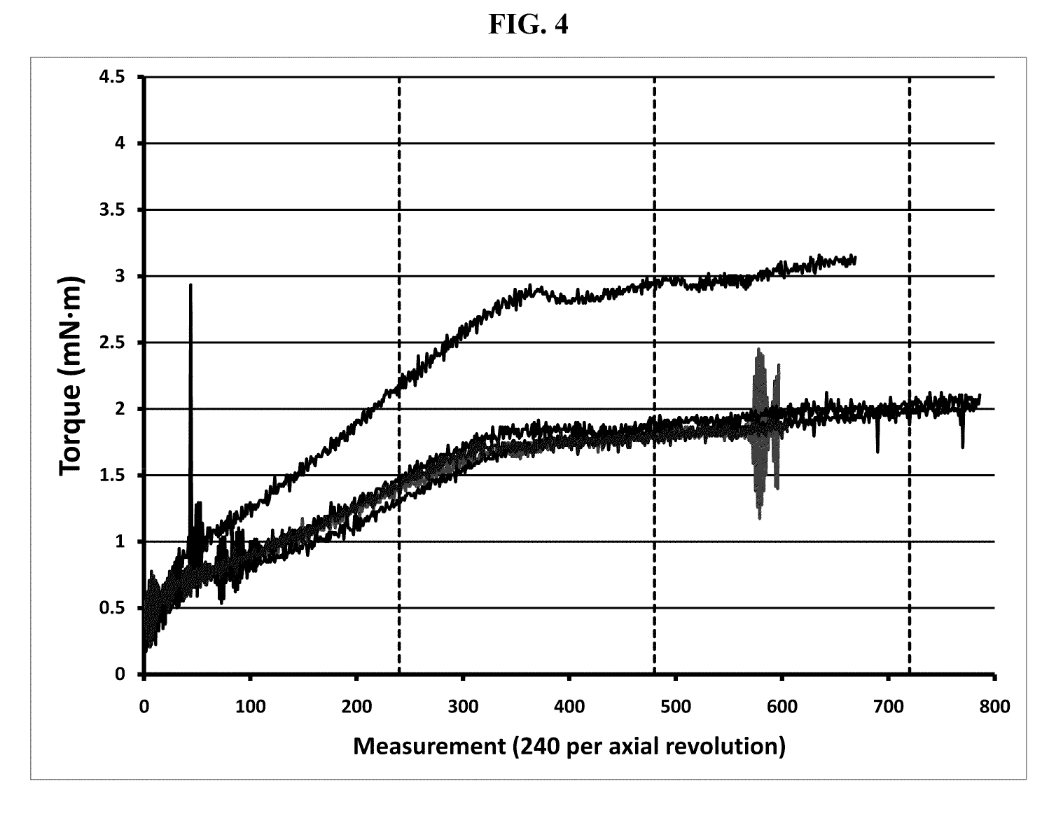

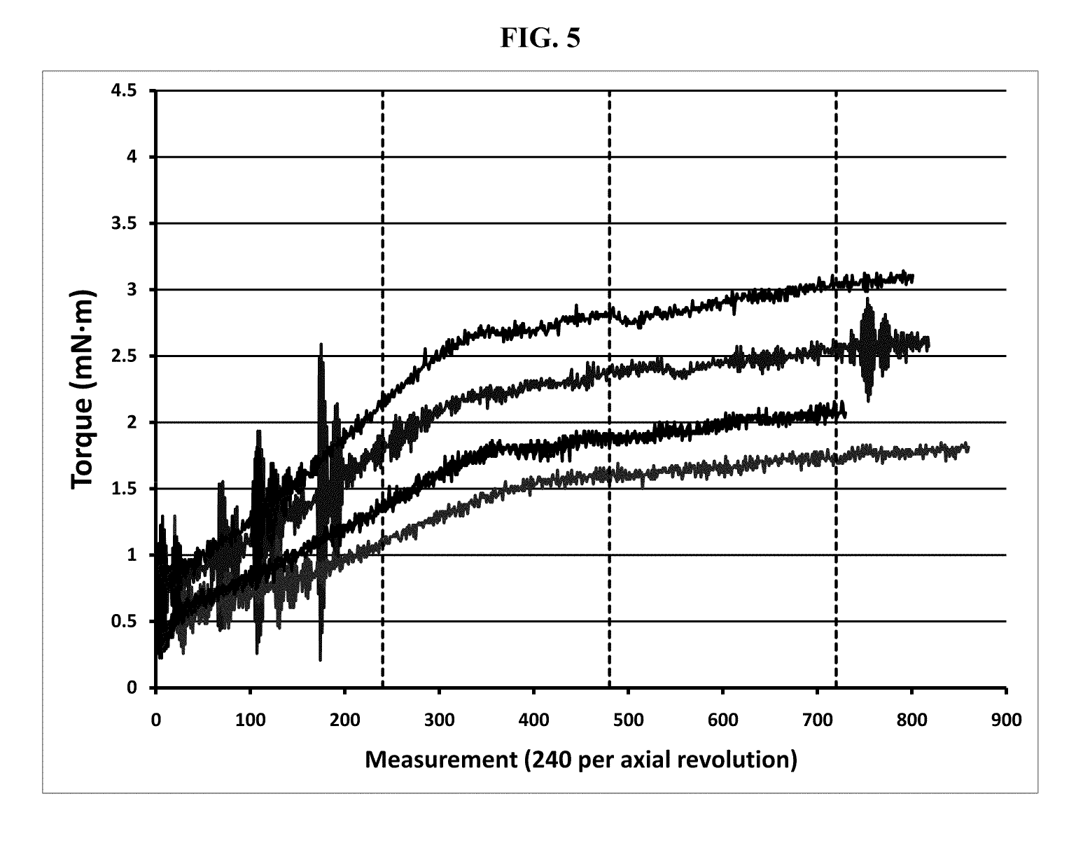

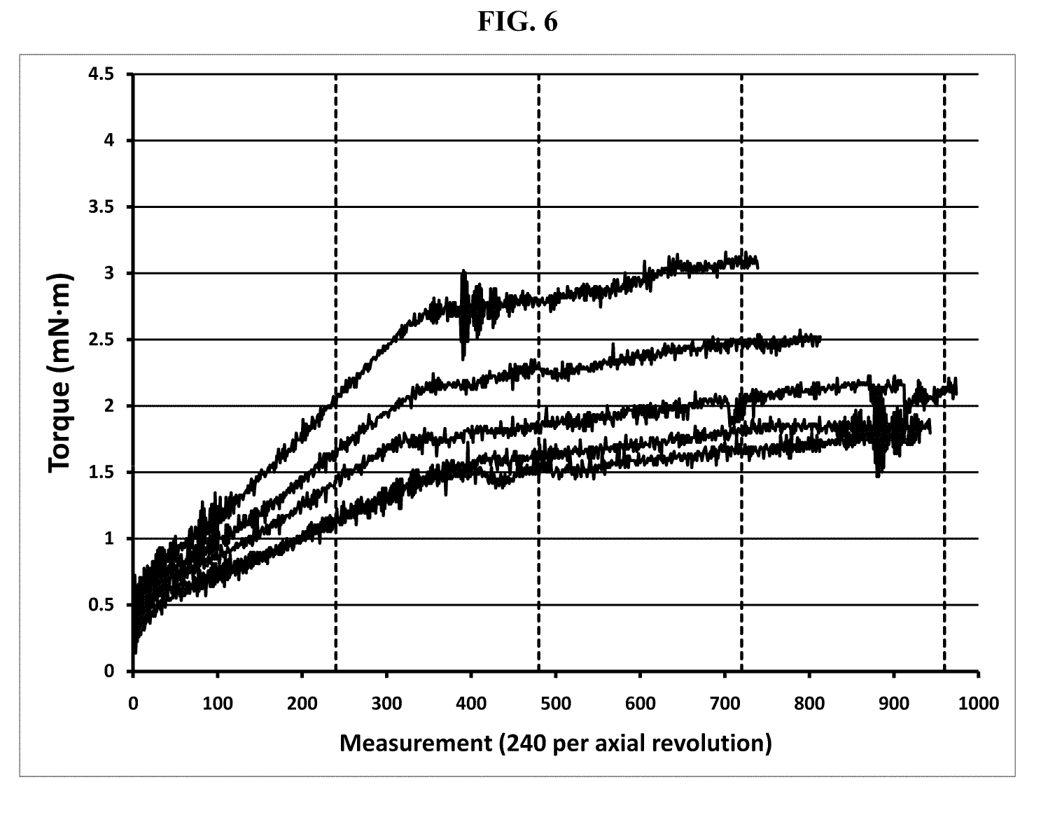

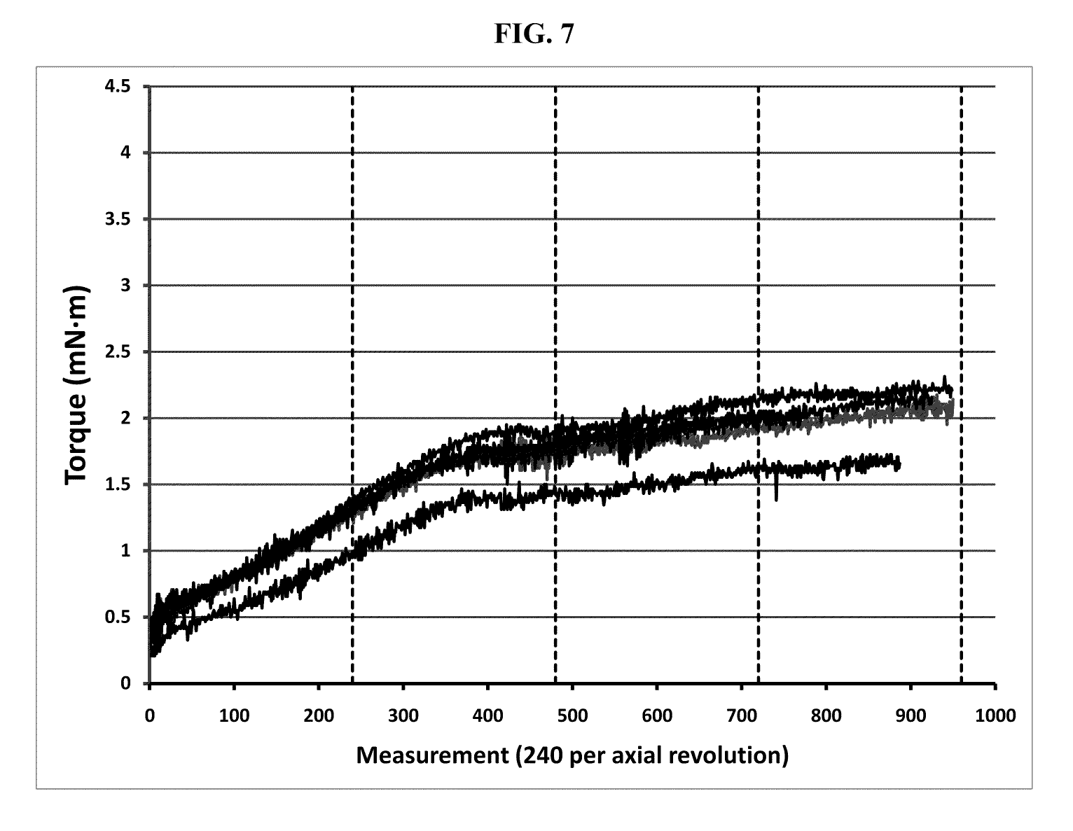

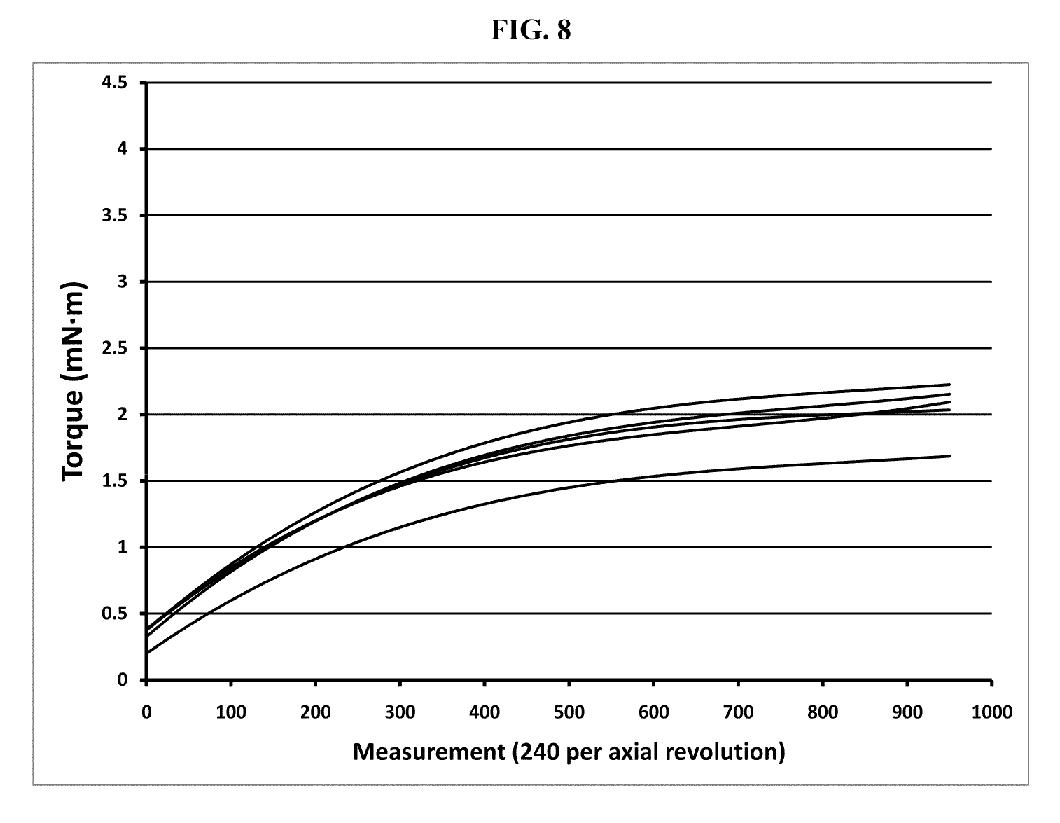

Each of FIGS. 4-8 show data sets of wire samples that have been heat treated by being placed in a stainless steel pan and inserted into an oven which was pre-heated to about 500° C. The difference between the experimental groups was the amount of time the test samples of a particular group were kept in the oven. FIG. 4, for example, shows a graph of five data sets representing five separate test samples included in the first experimental group which remained in the oven for 15 minutes. FIG. 5 shows a graph of five data sets representing five separate test samples included in the second experimental group which remained in the oven for 45 minutes. FIG. 6 shows a graph of five data sets representing five separate test samples included in the third experimental group which remained in the oven for 90 minutes. FIG. 7 shows a graph of five data sets representing five separate test samples included in the fourth experimental group which remained in the oven for 120 minutes. FIG. 8 shows second order polynomial trend lines based on the data sets of the fourth experimental group so that the respective “signatures” of these data sets can be more clearly seen relative to one another.

Although the average torque value of the fourth experimental group was very similar to the average torque value of the control group, it was surprisingly discovered that the average angular deflection of the fourth experimental group demonstrated an increase of almost 250% relative to the average angular deflection of the control group. Additionally, the samples tested in the fourth experimental group demonstrated a cyclical fatigue of about 120 seconds as compared to about 30 seconds as demonstrated with respect to the samples tested in the control group. Also, the visual signatures of the individual data sets in FIG. 7 and FIG. 8 were more precisely aligned as best shown in FIG. 8. As a follow-up to the test results given above, more testing was performed with a focus on heating machined endodontic NiTi instruments as described above for about 120 minutes and gathering additional data.

The purpose of the additional analysis was to build upon the experimentation discussed above in which the inventor was able to modify certain physical properties of Nickel-Titanium through a specific heating process. Some goals for the additional tests are shown below in Table 2.

TABLE 2

| TEST | | | |
|---|---|---|---|
| ITEM | NAME | CRITERIA | ACCEPTANCE |
| 1 | Torque | 1.77 Minimum | Must pass Minimum |
| | | | Criteria per ADA |
| | | | 101 |
| 2 | Angular Deflection | 360° Minimum | Must pass Minimum |
| | | | Criteria per ADA |
| | | | 101 |
| 3 | Cyclical Fatigue | 10-Series Equivalent | Must be greater than |
| | | | Industry equivalence |
| 4 | Flexibility | 10-Series Equivalent | Must be less than |
| | | | Industry equivalence |
| 5 | Clinician Feedback | Inquiry | Positive Feedback |

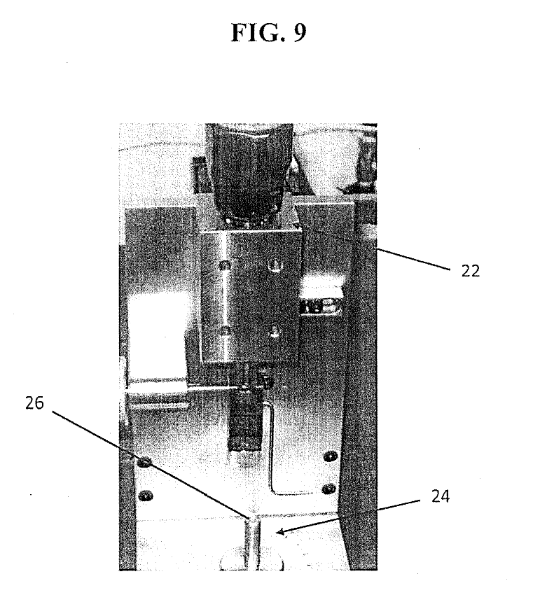

The additional testing followed the guidelines found in ADA no. 28 (sections 6.4 and 6.5), ADA no. 101, and ISO 3630-1 (sections 7.4 and 7.5), the contents of which are incorporated herein by reference in their entireties. Cyclical fatigue testing is not an ISO standard test, but it has been utilized in the testing of rotary Nickel-Titanium instruments over the past few years. Such cyclical fatigue testing includes a motor unit 22 as shown in FIG. 9 set at, for example, about 300 rpm to simulate the speed of an instrument as used during, for example, a root canal procedure. A Ni—Ti test instrument is lowered into a simulated canal structure 24 which may be set at about 90° relative to the plane of rotation of the test instrument, until the depth of a calibration line along the test instrument is reached at, for example, about 19 millimeters in reference to a first end 26 of the simulated canal structure 24. The amount of time the test instrument is rotated prior to breaking or otherwise failing is recorded so as to determine how long it took, under controlled conditions, for the test instrument to break.

No less than twenty machined endodontic NiTi instruments which had been heat treated in a 500° C. oven for about 120 minutes were tested according to the criteria set forth above in Table 2. More specifically, the tested instruments were 10 Series™ endodontic files offered by D&S Dental, LLC of Johnson City, Tenn., the files having a total length of about 25 mm, a working length of about 10 mm, and a taper rate of 0.04 mm/mm. An important aspect of the method described herein is heat treating after machining of a NiTi dental instrument has a profound effect on the physical properties of the machined instrument. Table 3A below summarizes the test results.

TABLE 3A

| ITEM | NAME | CRITERIA | RESULTS | COMMENTS |
|---|---|---|---|---|
| 1 | Torque | 1.77 mN · m | Worst Case | Passed |
| | | Minimum | 4 mN · m. | |
| 2 | Angular | 360° Minimum | Worst Case | Passed |
| | Deflection | | 510° | |
| 3 | Cyclical Fatigue | 10-Series | Mean of 160.79 | Passed |
| | | 25 seconds @ 90° | seconds with a | |
| | | | Standard Deviation | |
| | | | of 38 seconds | |
| 4 | Flexibility | 10-Series | Mean of 18 mN · m | 5 pieces were tested |
| | | 50 mN · m @ 45° | @ 45° | for amount of torque |
| | | | | needed to reach 45°. |
| | | | | Passed |
| 5 | Clinician | Inquiry | Pros: Good Cutting | Marginal |
| | Feedback | | ability, No breakage | |
| | | | Cons: Too flexible, | |
| | | | loss of tactile feel | |

The test results overall showed notable improvement in all categories listed in Table 3A. Table 3B shows specific product comparisons between different brands of endodontic instruments. The torque measurements for instruments treated using the method described above were all still well above the minimum standards set forth in ADA no. 28 (sections 6.4 and 6.5), ADA no. 101, and ISO 3630-1 (sections 7.4 and 7.5).

TABLE 3B

| With CM ™ Process | Torque (mN · m) | Without CM ™ Process | Torque (mN · m) |
|---|---|---|---|
| 10-Series 25_04 | 4.4995 | 10-Series 25_04 | 7.0307 |
| 10-Series 40_04 | 13.3086 | 10-Series 40_04 | 21.9641 |
| Typhoon 25_04 | 1.6006 | Typhoon 25_04 | 3.1405 |
| Typhoon 40_04 | 5.2195 | Typhoon 40_04 | 9.4911 |
| (no data) | (no data) | Twisted 25_04 | 1.4918 |
| (no data) | (no data) | Twisted 40_04 | 3.4895 |
| (no data) | (no data) | Vortex 25_04 | 3.3289 |
| (no data) | (no data) | Vortex 40_04 | 9.7674 |

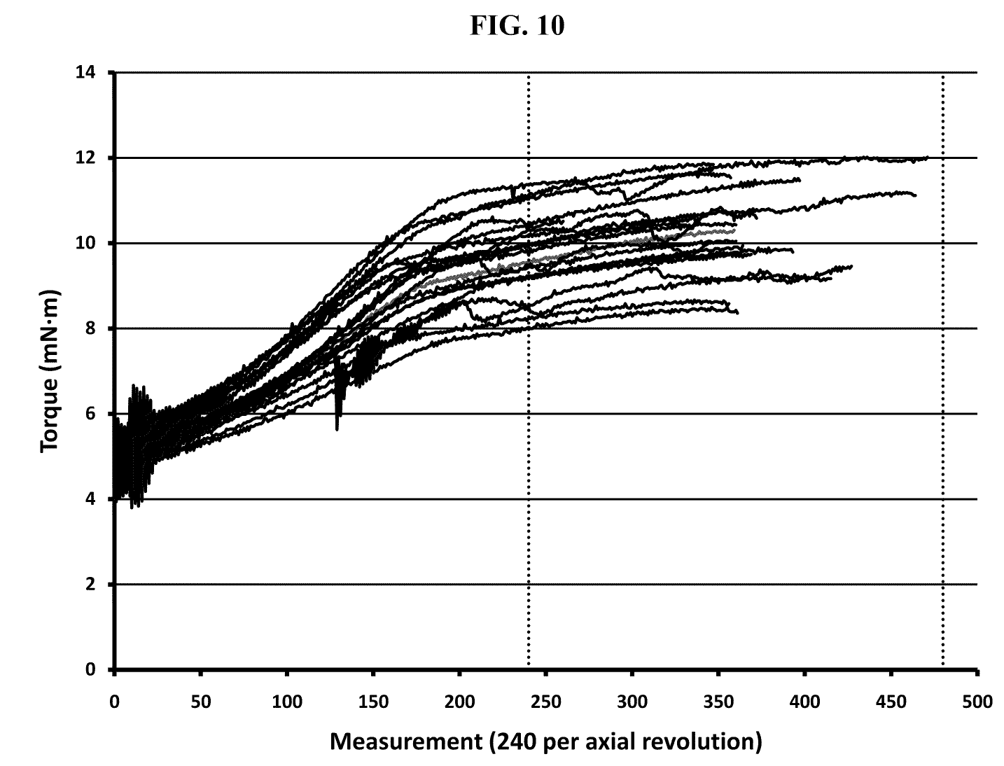

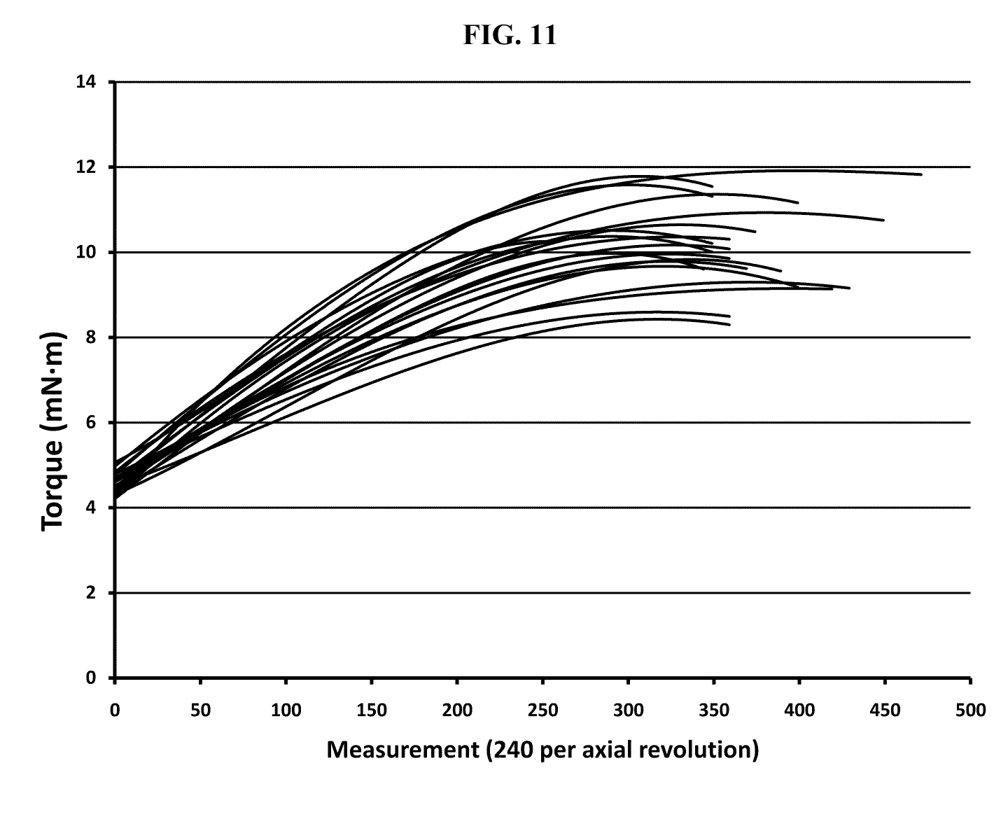

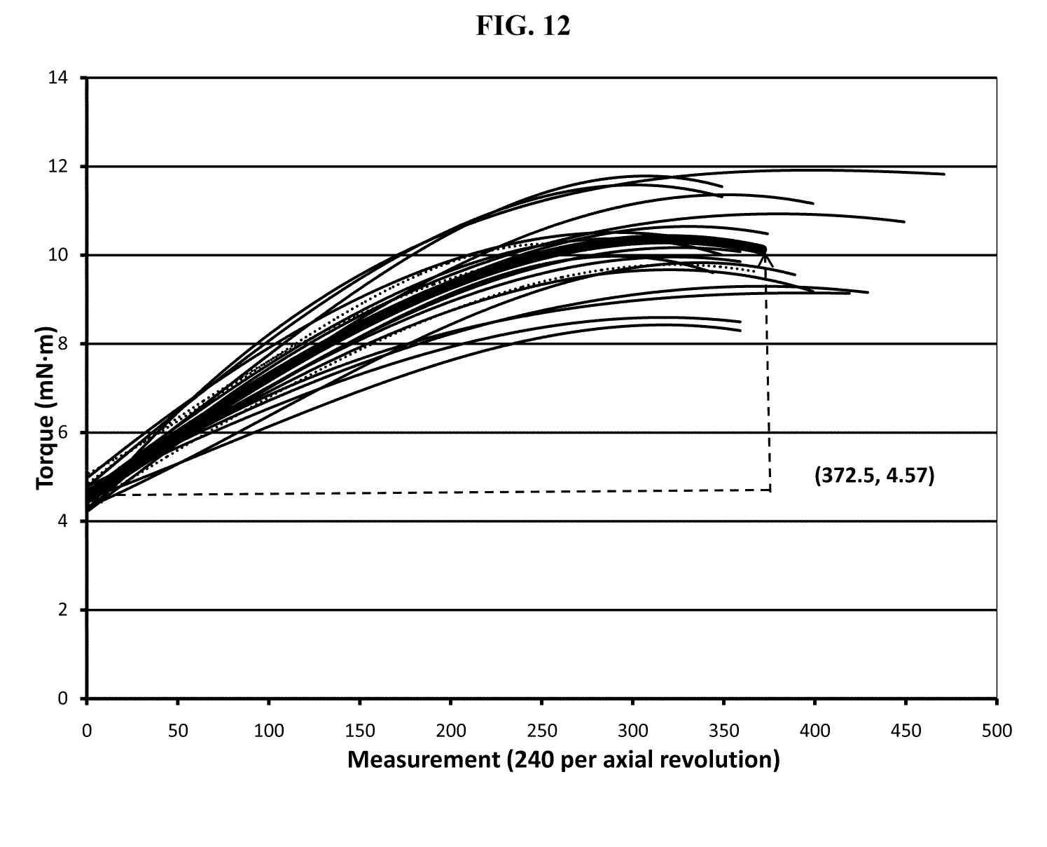

The graph shown in FIG. 10 shows the twenty samples as plotted with respect to torque (vertical axis) versus angular deflection wherein 240 data measurements were taken per one 360° (axial) revolution of a tested sample. FIG. 11 shows trendlines plotted based on third order polynomial equations to best model the data results for each test sample. FIG. 12 shows the trendlines from FIG. 11 along with a bold trendline generated and plotted based on the average values of the twenty trend lines representing each test sample. Table 4 shows the model equations used to generate each trendline in FIG. 11 as well as the equation used to generate and plot the bold trendline in FIG. 12.

TABLE 4
Coefficients as used in a third order polynomial equation
f(x) = Ax³ + Bx² + Cx + D.

| | |
|---|---|
| Test | Coefficients |

| Sample | A | B | C | D |
|---|---|---|---|---|
| 1 | −0.00000008 | −0.000004 | 0.0271 | 4.4365 |
| 2 | −0.00000008 | −0.000005 | 0.0291 | 4.4036 |
| 3 | −0.0000001 | 0.00002 | 0.0152 | 4.4996 |
| 4 | −0.0000001 | −0.000004 | 0.0346 | 4.7673 |
| 5 | −0.00000002 | −0.00004 | 0.0321 | 4.8333 |
| 6 | −0.00000005 | −0.000007 | 0.0195 | 4.7131 |
| 7 | −0.00000008 | −0.0000006 | 0.0253 | 4.3494 |
| 8 | 0.00000007 | −0.0001 | 0.0491 | 4.2493 |
| 9 | −0.00000008 | −0.000005 | 0.0314 | 4.2093 |
| 10 | −0.0000001 | 0.00004 | 0.0182 | 4.3039 |
| 11 | −0.0000001 | −0.000007 | 0.0305 | 4.6517 |
| 12 | −0.00000008 | −0.000002 | 0.0252 | 4.6123 |
| 13 | −0.0000002 | 0.00003 | 0.03 | 4.6047 |
| 14 | −0.00000002 | −0.00002 | 0.0224 | 4.7004 |
| 15 | 0.00000003 | −0.00006 | 0.0287 | 4.5002 |
| 16 | −0.00000007 | −0.000003 | 0.0243 | 4.5967 |
| 17 | −0.0000003 | 0.00008 | 0.0209 | 5.063 |
| 18 | 0.00000002 | −0.00006 | 0.038 | 4.2322 |
| 19 | −0.0000002 | 0.00006 | 0.0285 | 4.7873 |
| 20 | −0.00000006 | −0.00003 | 0.033 | 4.9694 |

Based on the results of the follow-up tests, the average torque value for the samples tested was about 4.57 mN·m. The average number of measurements taken prior to instrument failure was 372.5 which corresponds to about 1.5 full axial revolutions (i.e., 372.5 measurements 240 measurements per axial revolutions). The values are shown in FIG. 12.

The results of the tests carried out above are promising because they demonstrate that heat treating an endodontic instrument to about 500° C. for about two hours or more after machining has taken place results in improved instrument flexibility. Such increased flexibility leads to an instrument such as the treated instrument 14′ shown in FIG. 1B to more closely follow the natural root canal 12 of the tooth 10 and exhibit less lateral forces along the inner surface of such root canal 12.

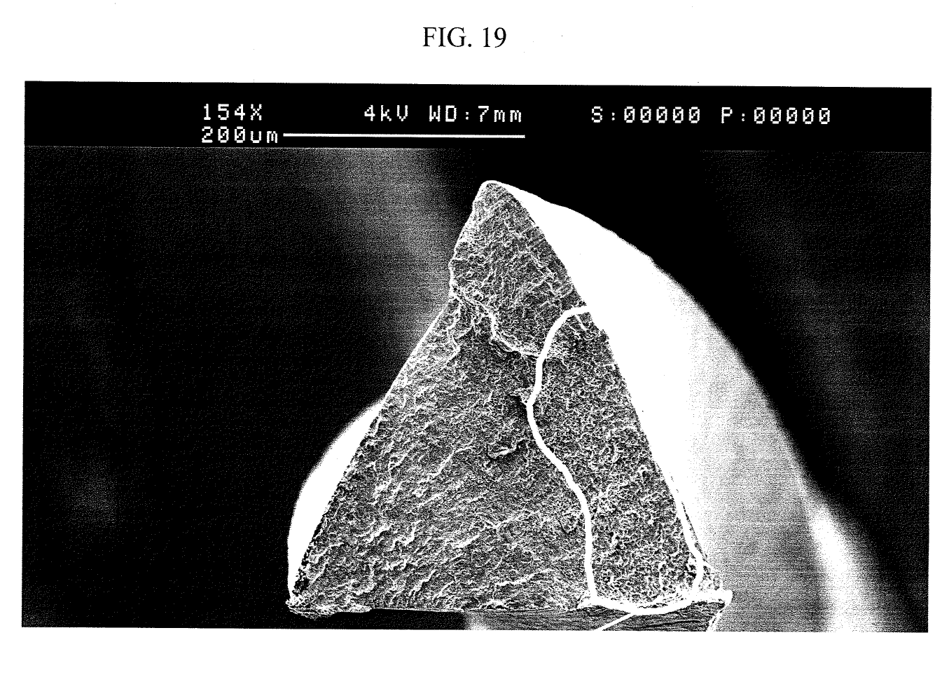

One specific example of improved cyclical fatigue is shown in FIG. 19 showing the torn cross section of a heat treated endodontic instrument tested at a speed 300 rpm, and dry (i.e., no irrigation solution). This testing was conducted for Applicants by the Department of Oral Biological & Medical Sciences at the University of British Colombia in Vancouver, British Colombia. The micrographs show that the instrument fractured, but a small portion 28 of the instrument held together and maintained the integrity of the instrument for an extended period of time such that the test lasted for over 3000 cycles. Typical NiTi instruments usually completely separate upon a relatively small fracture occurs, but the heat treated instrument shown in FIG. 19 behaved differently and maintained its integrity with a large and deep fracture for more than enough time for a user to have realized that the instrument was mechanically failing.

The improved cyclical fatigue measurements (as compared to untreated NiTi instruments) strongly suggests that endodontic instruments treated according to embodiments described herein will last longer and endure more stress prior to failing. This enhancement translates into less time spent extracting broken bits of instruments and more time accomplishing the goal of a particular endodontic procedure.

In one embodiment, a method is disclosed for treating medical instruments including placing a medical instrument into an environment held at least at about 450° C. to about 550° C., more preferably from about 475° C. to about 525° C., and most preferably from about 490° C. to about 510° C. for a period of from about 90 minutes to about 180 minutes and more preferably from about 120 minutes to about 150 minutes. The dental instrument is preferably an endodontic instrument made from at least about 50% of a superelastic alloy, and the instrument is preferably a file, reamer, or a broach. The superelastic alloy is preferably Nickel-Titanium. The heat treated medical instrument preferably is placed in a metal pan with freedom of movement during the heating step. In this and other related embodiments, no special treatment atmosphere is required and, in a preferred embodiment, simple air is used. Similarly, unlike other processes that require special quenching steps to obtain desired properties, Applicants' embodiments require no quenching steps. Heated instruments are preferably brought to ambient air temperature by natural conduction, convection, and radiation heat transfer.

Applicants have determined that the duration of heat treatment described herein is preferably a function of the core diameter of the instrument being treated. For example, instruments with core diameters ranging from about 1.9×10⁻² mm to about 3.1×10⁻² mm are preferably heat treated for at least 120 minutes; instruments with core diameters ranging from about 3.1×10⁻² mm to about 4.8×10⁻² mm are preferably heat treated for from at least 120 minutes to about 240 minutes; and instruments with core diameters greater than about 4.8×10⁻² mm are preferably heat treated for from at least 240 minutes to about 300 minutes. These ranges overlap somewhat because other factors also determine the effectiveness the heat treatment process including, for example, the particular helix angle(s) of an endodontic instrument.

In a related embodiment, flexibility of an elongate machined medical instrument is varied along its length axis by heat treating only one or more discrete portions of the medical instrument. In the following examples, it is to be assumed that the medical instrument is an endodontic instrument including a working portion approximately 10 mm in length, such 10 mm length including a distal end (tip) and a flute length end (rear), wherein the second end is adjacent a non-working portion of the endodontic instrument. The assumptions given herein are for illustrative purposes only and are not intended as a limitation on the technology as described herein.

In a first example, an endodontic instrument made from primarily a superelastic alloy such as NiTi may be selectively heat treated along about 2 mm adjacent the distal end (tip) of the instrument, resulting in an instrument with a tip having enhanced flexibility with the remainder of the instrument remaining relatively rigid.

In another example, an endodontic instrument made from primarily a superelastic alloy such as NiTi may be selectively heat treating a discrete cross section of an instrument having a length of about 1 mm to about 2 mm located about 5 mm from the tip of the instrument. This will result in a relatively rigid tip, flexible middle portion, and relatively rigid end portion of the working portion of the instrument.

In yet another example, an instrument is heat treated from the tip of the instrument to about 2 mm from the tip as well as heat treated from about 9 mm to about 10 mm from the tip of the instrument. This example would result in an instrument with relative flexibility near the tip, relative rigidity along a midsection of the working portion of the instrument (i.e., from about 3 mm from the tip to about 8 mm from the tip), and relative flexibility from about 9 mm to about 10 mm from the tip of the instrument.

Other discrete treatment options are contemplated herein for treatment of specific axial cross-sections of an endodontic instrument to effect specific physical property alterations along the instrument's length as desired. The specific treatment may be accomplished using focused energy at certain points along an endodontic instrument and/or placing a resistance forming layer or layers on sections of an instrument that are not to be heat treated.

In addition to the treated endodontic instruments and related methods described above, a related embodiment includes a step of electropolishing an endodontic instrument prior to the various heat treatments described above. Electropolishing is a technique that has been used in the art for the purpose of removing surface flaws in endodontic instruments. However, Applicants have surprisingly found that electropolishing an endodontic instrument prior to heat treating the endodontic instrument as described above results in improved instrument characteristics.

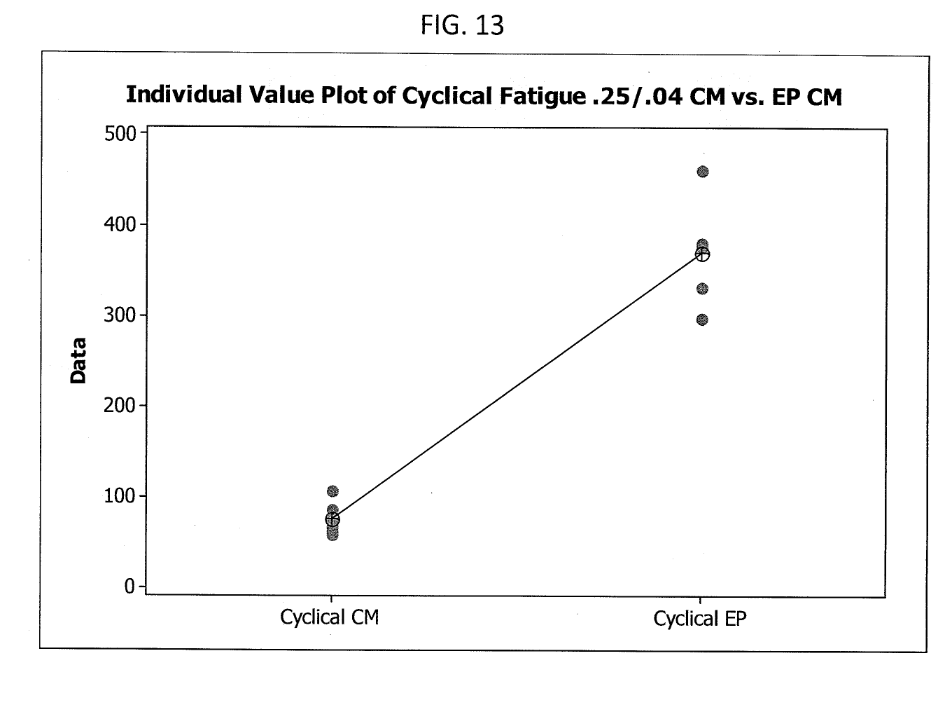

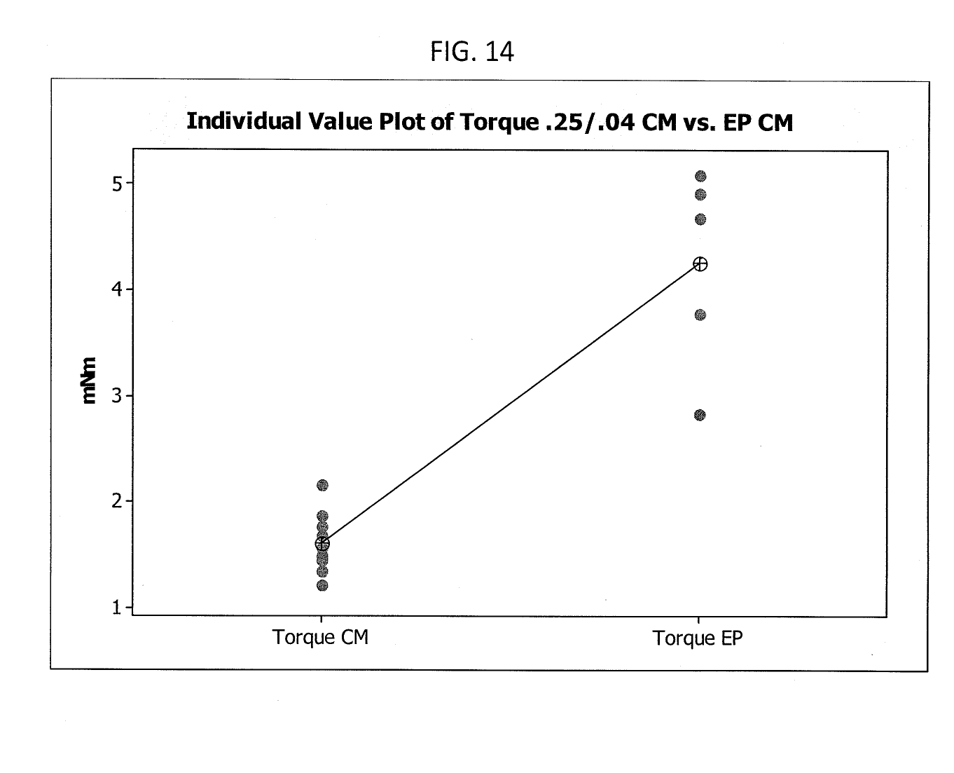

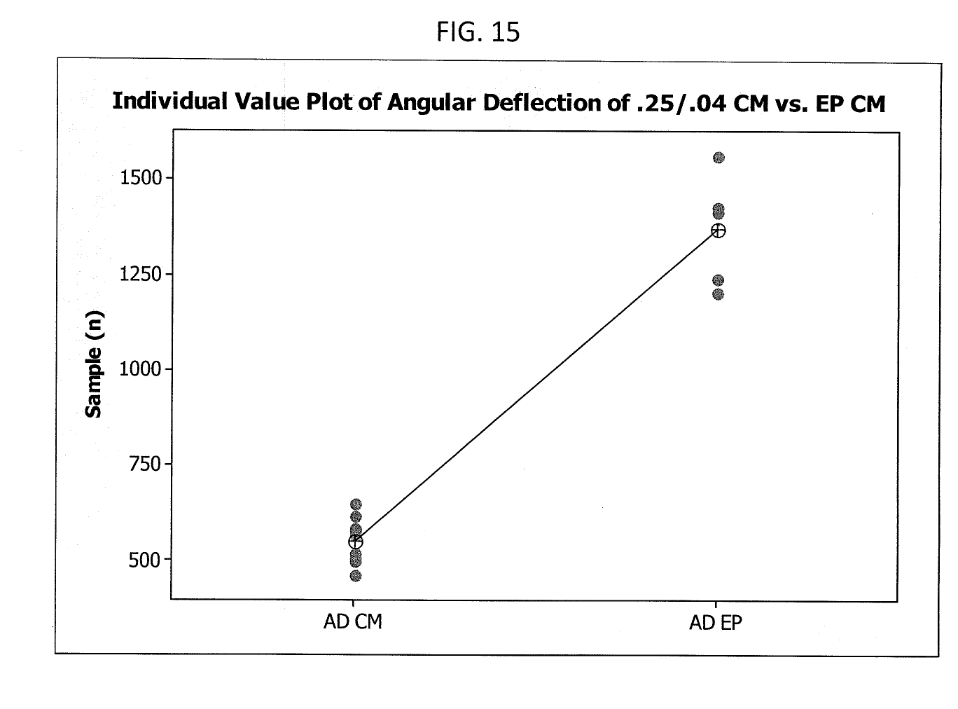

Applicants tested ten pieces of 0.25/0.04 (size/taper rate) Typhoon brand endodontic instruments in May 2010. The test results indicated substantially improved cyclical fatigue at 60° (angular), improved torque, and improved angular deflection when compared to similarly heat treated endodontic instruments that were not electropolished prior to heat treatment. The results are summarized below in Table 5, and graphically shown in FIGS. 13-15 wherein FIG. 13 shows the comparative cyclical fatigue measurements, FIG. 14 shows the comparative torque measurements, and FIG. 15 shows the comparative angular deflection measurements. The parameters used for the testing included use of a Esma Electro-polishing machine with E272 Acid wherein the temperature of the acid was kept at about 80° C. Each run lasted approximately 240 seconds and approximately 25 volts of DC power was applied through the positive and negative circuits of the electro-polishing machine.

TABLE 5

| | | | | COMMENTS | | | | |
|---|---|---|---|---|---|---|---|---|
| ITEM | NAME | CRITERIA | RESULTS | | N | Mean | StDev | SE Mean |
| 1 | Cyclical | Past product group | Must be greater | Cyclical CM | 7 | 76.0 | 16.8 | 6.4 |
| | Fatigue @ 60° | comparison | than control group | Cyclical EP | 5 | 370.0 | 61.6 | 28 |
| 2 | Torque | Past product group | Must be greater | Torque CM | 9 | 1.613 | 0.288 | 0.096 |
| | | comparison | than control group | Torque EP | 5 | 4.261 | 0.946 | 0.42 |
| 3 | Angular | Past product group | Must be greater | A D CM | 10 | 549.8 | 58.3 | 18 |
| | Deflection | comparison | than control group | A D EP | 5 | 1370 | 146 | 65 |

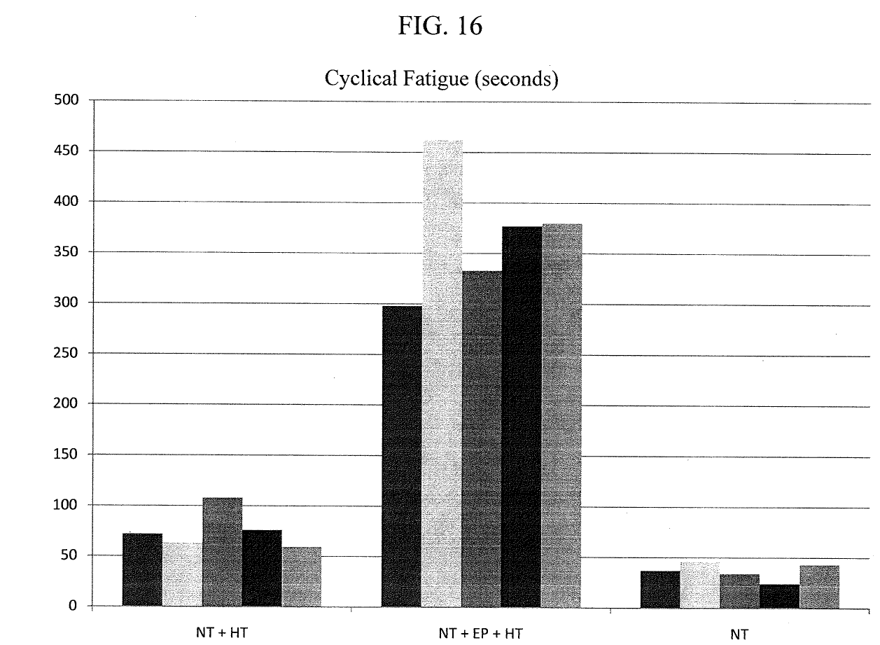

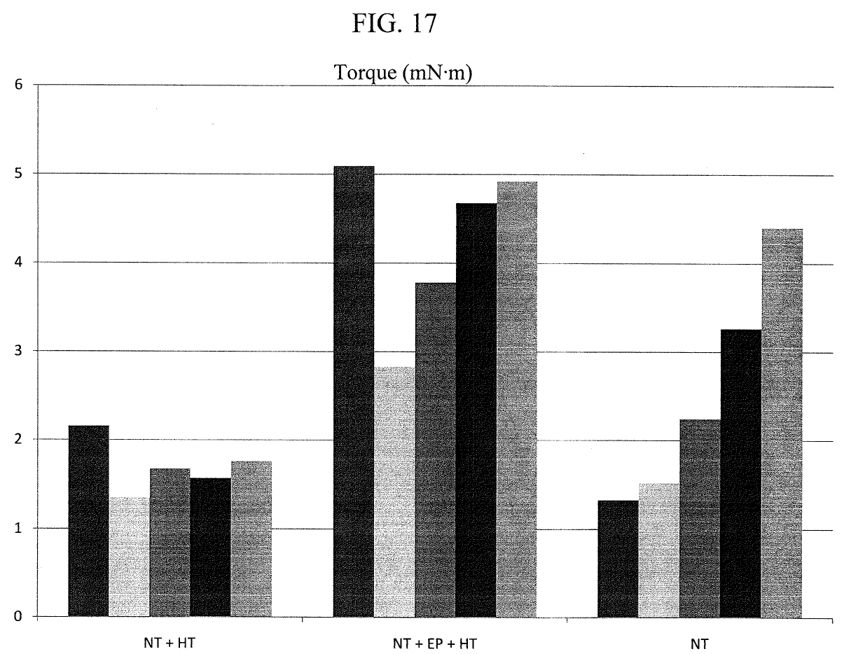

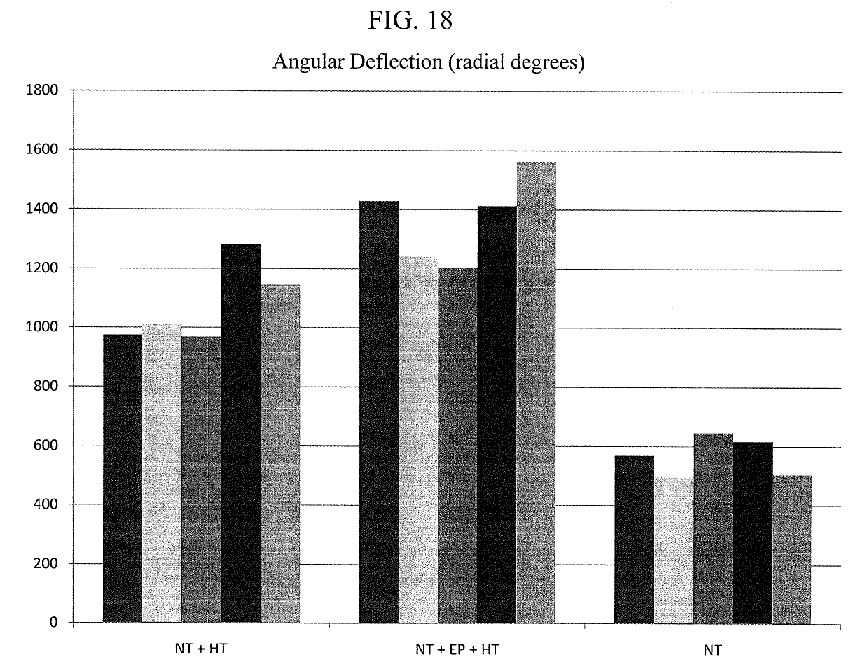

Applicants further tested at least five different groups of nickel-titanium endodontic instruments wherein some had not been heat treated, some had been treated without a prior electropolishing step, and the remainder were heat treated with a prior electropolishing step. The comparative data is shown in Table 6 below as well FIGS. 16-18 wherein FIG. 16 shows comparative cyclical fatigue, FIG. 17 shows comparative torque measurements, and FIG. 18 shows comparative angular deflection measurements.

TABLE 6

| Cyclical Fatigue | | | Torque | | | Angular Deflection | | |
|---|---|---|---|---|---|---|---|---|
| NT + HT | NT + EP + HT | NT | NT + HT | NT + EP + HT | NT | NT + HT | NT + EP + HT | NT |
| 72 | 298 | 37 | 2.158251975 | 5.09347466 | 1.329483217 | 975 | 1428 | 569 |
| 63 | 462 | 46 | 1.346749233 | 2.83162659 | 1.519409391 | 1012 | 1241 | 498 |
| 108 | 333 | 34 | 1.674803533 | 3.78125746 | 2.244582054 | 969 | 1205 | 647 |
| 76 | 377 | 24 | 1.571207438 | 4.67909028 | 3.263276987 | 1283 | 1413 | 617 |
| 59 | 380 | 43 | 1.761133612 | 4.9208145 | 4.40283403 | 1146 | 1561 | 506 |

NT = Nickel-Titanium instrument
HT = Heat treatment step
EP = Electropolishing step

Based on the results shown in FIGS. 13-18, Table 5, and Table 6, this disclosure further includes a method for treating medical instruments including electropolishing a medical instrument; and placing a medical instrument into an environment held at least at about 450° C. to about 550° C., more preferably from about 475° C. to about 525° C., and most preferably from about 490° C. to about 510° C. for a period of from about 90 minutes to about 180 minutes and more preferably from about 120 minutes to about 150 minutes. The dental instrument is preferably an endodontic instrument made from at least about 50% of a superelastic alloy, and the instrument is preferably a file, reamer, or a broach. The superelastic alloy is preferably Nickel-Titanium. The heat treated medical instrument preferably is placed in a metal pan with freedom of movement during the heating step.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method for modifying a physical characteristic of a medical instrument, the method comprising the steps of placing a medical instrument in a heated environment having a temperature of from about 450° C. to about 550° C. for from about 90 minutes to about 300 minutes, wherein the medical instrument is made from at least about 50% by mass of a superelastic alloy.

2. The method of claim 1 wherein the medical instrument comprises an endodontic instrument.

3. The method of claim 2 wherein the placing step further includes placing the endodontic instrument in a heated gaseous environment having a gas temperature of from about 490° C. to about 510° C.

4. The method of claim 3 wherein the gaseous environment comprises a gas consisting essentially of air.

5. The method of claim 2 wherein the placing step includes placing the endodontic instrument in the heated environment for a period from about 120 minutes to about 150 minutes.

6. The method of claim 2 wherein the placing step includes placing the endodontic instrument in the heated environment for a period from about 180 minutes to about 300 minutes.

7. The method of claim 2 further comprising the step of machining the endodontic instrument to form a working portion prior to placing the endodontic instrument in the heated environment.

8. The method of claim 2 further comprising the step of placing a resistance layer along a first section of the endodontic instrument prior to placing the endodontic instrument in the heated environment, wherein the resistance layer prevents the first section from undergoing heat treatment in the heated environment.

9. The method of claim 2, wherein the endodontic instrument comprises a tapered endodontic instrument made of a nickel-titanium composition and configured as a file, rasp, broach, or other device for cleaning, scraping, extirpating, and/or debriding a root canal of a tooth.

10. The method of claim 2 further comprising a step of electropolishing the endodontic instrument prior to placing the instrument in the heated environment.

11. The method of step 2 wherein the placing step further comprises a step selected from the group consisting of heat treating the endodontic instrument for at least 120 minutes if the endodontic instrument has a core diameter ranging from about 1.9×10⁻² mm to about 3.1×10⁻² mm; heat treating the endodontic instrument for from at least 120 minutes to about 240 minutes if the endodontic instrument has a core diameter ranging from about 3.1×10⁻² mm to about 4.8×10⁻² mm; and heat treating the endodontic instrument for from at least 240 minutes to about 300 minutes if the endodontic instrument has a core diameter greater than about 4.8×10⁻² mm.

12. The method of claim 3 further comprising the step of cooling the heated instrument using natural heat transfer mechanisms in ambient air.

13. An endodontic instrument with modified memory characteristics, the endodontic instrument made by the method comprising the steps of placing an endodontic instrument in a heated environment having a temperature of from about 450° C. to about 550° C. for from about 90 to about 300 minutes, wherein the endodontic instrument is made from at least about 50% by mass of a superelastic alloy.

14. The endodontic instrument of claim 9 wherein the method for modifying a physical characteristic of a endodontic instrument is made by further including a step of electropolishing the endodontic instrument prior to placing the endodontic instrument in the heated environment.

15. The endodontic instrument of claim 13 wherein the step of placing the endodontic instrument in a heated environment further comprises placing the endodontic instrument in the heated environment for from about 180 minutes to about 300 minutes.

16. The endodontic instrument of claim 14 wherein the step of placing the endodontic instrument in a heated environment further comprises placing the endodontic instrument in the heated environment for from about 180 minutes to about 300 minutes.
